(19) United States
(12) Patent Application Publication
(10) Pub. No.: US 2010/0160600 A1
(43) Pub. Date: Jun. 24, 2010

(54) RESIN COMPOSITION FOR OPTICAL MATERIAL AND ITS SHAPED ARTICLE, OPTICAL COMPONENT AND LENS

(75) Inventor: Seiya SAKURAI, Minami-ashigara-shi (JP)

Correspondence Address: YOUNG & THOMPSON, 209 Madison Street, Suite 500, Alexandria, VA, 22314, US

(73) Assignee: FUJIFILM CORPORATION, Tokyo (JP)

(21) Appl. No.: 12/644,826

(22) Filed: Dec. 22, 2009

(30) Foreign Application Priority Data
Dec. 22, 2008 (JP) 2008-326110

(51) Int. Cl. C08G 61/00; G02B 1/00

(52) U.S. Cl. 528/397; 359/642

(57) ABSTRACT

A resin composition for optical material, having a refractive index nD at a wavelength of 589 nm of at least 1.37, an Abbe's number vD satisfying vD≦63 and vD≦430−250×nD, and a glass transition temperature of not lower than 100° C. has high refractivity, low dispersiveness, heat resistance, good transparency and good releasability from mold.

### BACKGROUND OF THE INVENTION

1. Field of the Invention

The present invention relates to a resin composition for optical material having a large Abbe's number and excellent in high refractivity, transparency, lightweightness and workability and excellent in releasability from mold. The present invention also relates to optical components such as lens substrates comprising the material (e.g., lenses for spectacles, lenses for optical instruments, lenses for optoelectronics, laser lenses, pickup lenses, in-vehicle camera lenses, mobile camera lenses, digital camera lenses, OHP lenses, lenses constituting microlens arrays), etc.

2. Description of the Related Art

As compared with glass, a transparent resin material has various advantages in that it is excellent in lightweightness, impact resistance and shapability and is economical; and recently, resin is being much used for optical glass in the art of optical components such as lenses and others.

One typical transparent thermoplastic resin material is a polycarbonate resin. In particular, a polycarbonate resin produced by the use of 2,2-bis(4-hydroxyphenyl)propane (generally called bisphenol A) as a starting material has many advantages in that it is excellent in transparency, more lightweight than glass and excellent in impact resistance and that it is applicable to industrial-scale mass-production of shaped articles as being able to be shaped in melt; and therefore the resin of the type is being much used as optical components in various fields. The resin has a relatively high refractive index of 1.58 or so, but its Abbe's number indicating the degree of refractivity dispersiveness is around 30 and is low, or that is, the resin is poor in the balance between the refractivity and the dispersiveness characteristic thereof. At present, therefore, the resin is limited in point of the range of its applications to optical components. For example, regarding lenses for spectacles that are one typical example of optical components, it is known that the materials for those lenses preferably have an Abbe's number of at least 40 when the visibility function thereof is taken into consideration (Quarterly Journal of Chemical Review, No. 39, Refractivity Control of Transparent Polymer, edited by the Chemical Society of Japan); and in case where a polycarbonate resin produced by the use of bisphenol A as a starting material is directly used for those lenses as it is, the lenses formed of the resin could hardly have the desired characteristics.

Technique and Application of Plastic Lenses, CMC Publishing (2003) states as follows: The optical-system aberration to occur in an imaging instrument includes monochromatic aberration such as spherical aberration, coma aberration, astigmatism, distortion aberration and curvature aberration, and chromatic aberration. In particular, when chromatic aberration increases, then color migration increases thereby to noticeably worsen the quality of color images. Correction of chromatic aberration may be attained by a combined lens system where a high-refractivity lens is combined with a lens having a large Abbe's number.

As a high-refractivity lens material for correction of chromatic aberration, polycarbonate is known; and as a lens material having a high Abbe's number, calcium fluoride is known. Calcium chloride has a refractive index of at least 1.43 and has an extremely high Abbe's number of 95, and is therefore useful as a lens material; however, differing from polycarbonate, this is a crystal of an inorganic compound and therefore requires cutting and polishing of a single crystal of the compound for use as lenses. Further, as soft and readily scratched and cleaved, this is problematic in that its production cost is high and it is unsuitable to industrial-scale mass-production.

JP-A 1-131215 describes a fluorine ring structure-having polymer having an Abbe's number of around 90; however, the refractive index of the polymer is 1.34 and is low for use as lenses. Accordingly, a resin material having a refractive index on the same level as that of calcium fluoride and having a high Abbe's number is desired.

JP-A 2007-177046 describes a ring-opened polymer of a fluoro-cyclic olefin having a refractive index of at most 1.48, disclosing examples of the polymer having a refractive index of 1.45 and a relatively high Abbe's number of 69; however, the glass transition temperature of the polymer is lower than 80° C. and therefore the heat resistance of the polymer is insufficient for use for lenses.

Accordingly, a resin material substitutive for calcium fluoride, having a high refractive index and a high Abbe's number and having sufficient heat resistance fox use for lenses, could not as yet been found out, and its development is much desired.

### SUMMARY OF THE INVENTION

The present invention has been made in consideration of the above-mentioned current situation in the art, and its object is to provide a resin composition for optical material comprising a polymer which has high refractivity, low dispersiveness (high Abbe's number) and heat resistance, and to provide its shaped article, as well as an optical component and a lens comprising the material.

The present inventors have assiduously studied for the purpose of attaining the above-mentioned object, and as a result, have found that a resin composition for optical material comprising a polymer has high refractivity, low dispersiveness (high Abbe's number), heat resistance and good transparency and has good releasability from mold, and have completed the invention described below.

[1] A resin composition for optical material, having a refractive index nD at a wavelength of 589 nm of at least 1.37, an Abbe's number vD satisfying vD≦63 and vD≦430=250×nD, and a glass transition temperature of not lower than 100° C.
[2] The resin composition for optical material of [1], having a refractive index nD at a wavelength of 589 nm of at least 1.42.
[3] A resin composition for optical material, containing a polymer having a fluorine-containing ring structure and having a recurring unit represented by the following formula (1):

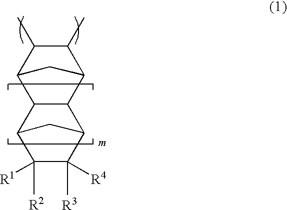

wherein R¹ to R⁴ each independently represent a hydrogen atom, a fluorine atom, a substituted or unsubstituted alkyl group, an alkyl group having a fluorine atom, an alkoxy group having a fluorine atom, an ether bond-containing alkyl group having a fluorine atom, or a substituent of —COOR⁵ or —OCOR⁵; at least two of R¹ to R⁴ may bond to each other to form a ring structure;
R⁵ represents a substituted or unsubstituted alkyl group, or an alkyl group having a fluorine atom;
the compound contains at least one fluorine atom in R¹ to R⁴; m indicates 0 or 1.

[4] The resin composition for optical material of [3], wherein the weight-average molecular weight of the fluorine-containing ring structure-having polymer is at least 20000.

[5] The resin composition for optical material of [3] or [4], wherein the fluorine atom content in the fluorine-containing ring structure-having polymer is from 10% by mass to 75% by mass relative to the mass of the fluorine-containing ring structure-having polymer.
[6] The resin composition for optical material of any one of [3] to [5], which has a glass transition temperature of not lower than 100° C.
[7] The resin composition for optical material of any one of [3] to [6], of which the refractive index nD at a wavelength of 589 nm is at least 1.42.
[8] The resin composition for optical material of any one of [3] to [7], of which the Abbe's number vD at a wavelength of 589 nm satisfies vD≦63.
[9] The resin composition for optical material of any one of [3] to [8], of which the Abbe's number vD at a wavelength of 589 nm satisfies vD 430−250×nD (where nD indicates the refractive index of the resin composition at a wavelength of 589 nm).
[10] A shaped article formed by shaping the resin composition for optical material of any one of [1] to [9].
[11] The shaped article of [10], of which the light transmittance at a wavelength of 589 nm through a thickness thereof of 1 mm is at least 50%.
[12] An optical component formed by shaping the resin composition for optical material of any one of [1] to [9].
[13] A lens formed by shaping the resin composition for optical material of any one of [1] to [9].

According to the invention, there is provided a resin composition for optical material having high refractivity, low dispersiveness (high Abbe's number), heat resistance and good transparency and having good releasability from mold. The resin composition for optical material of the invention is readily shaped into shaped articles such as typically lens substrates and other optical components, and in particular, when the material is thermoplastic, it can be extremely readily shaped. The shaped articles formed of the resin composition for optical material of the invention have excellent transparency and have high refractivity and a high Abbe's number.

### BEST MODE FOR CARRYING OUT THE INVENTION

The resin composition for optical material and shaped articles such as lens substrates and others comprising the material are described in detail hereinunder. The description of the constitutive elements of the invention given hereinunder is for some typical embodiments of the invention, to which, however, the invention should not be limited. In this description, the numerical range expressed by the wording “a number to another number” means the range that falls between the former number indicating the lowermost limit of the range and the latter number indicating the uppermost limit thereof. The percent by mass in the specification is equal to percent by weight.

### [Resin Composition for Optical Material]

### (Physical Properties)

The resin composition for optical material of the invention is, from the viewpoint of the physical properties thereof, characterized by having a refractive index nD at a wavelength of 589 nm of at least 1.37, an Abbe's number vD satisfying vD≦63 and vD≦430−250×nD, and a glass transition temperature of not lower than 100° C.

For use for lenses, the resin composition for optical material of the invention is preferably such that its refractive index nD is at least 1.37, more preferably at least 1.39, even more preferably at least 1.42 from the viewpoint of thinning the lenses.

In this description, the Abbe's number vD may be computed according to the following formula (A) where nD, nF and nC each are a refractive index of the composition measured at a wavelength of 589 nm, 486 nm and 656 nm, respectively.

$$vD = \frac{nD - 1}{n F - nC} \qquad ( A )$$

For use for lenses, the resin composition for optical material of the invention is preferably such that its Abbe's number vD is at least 63, more preferably at least 67, even more preferably at least 70 from the viewpoint of reducing the chromatic aberration through the lenses.

For use for lenses, the Abbe's number of the resin composition preferably satisfies vD Z 430−250×nD from the viewpoint of satisfying both the requirements of thickness reduction and chromatic aberration reduction.

The resin composition for optical material of the invention is preferably such that its glass transition temperature is not lower than 100° C., more preferably from 120 to 300° C., even more preferably from 140 to 250° C. from the viewpoint of the heat resistance of the shaped articles of the composition. When the composition has a glass transition temperature of not lower than 100° C., then it may readily have good heat resistance. When the composition has a glass transition temperature of not higher than 400° C., then it may be readily shaped and worked.

From the viewpoint of its use for optical components, the resin composition for optical material of the invention is preferably such that its light transmittance at a wavelength of 589 nm through a thickness thereof of 1 mm is at least 50%. More preferably, the light transmittance of the composition through a thickness of 1 mm is at least 65%. Even more preferably, the light transmittance of the composition at a wavelength of 589 nm through a thickness thereof of 1 mm is at least 75%, as readily giving lens substrates having more preferred properties. The light transmittance through a thickness of 1 mm in the invention is determined as follows: The resin composition for optical material of the invention is shaped into a substrate having a thickness of 1.0 mm, and this is analyzed with a UV-visible light absorption spectrometer (UV-3100, by Shimadzu).

### (Fluorine-Containing Ring Structure-Having Polymer)

The invention provides a resin composition for optical material, containing a polymer having a fluorine-containing ring structure and having a recurring unit represented by the following formula (1):

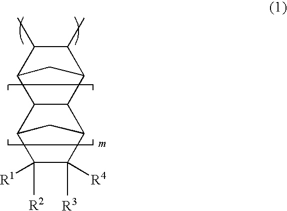

In formula (1), R¹ to R⁴ each independently represent a hydrogen atom, a fluorine atom, a substituted or unsubstituted alkyl group, an alkyl group having a fluorine atom, an alkoxy group having a fluorine atom, an ether bond-containing alkyl group having a fluorine atom, or a substituent of —COOR⁵ or —OCOR⁵; at least two of R¹ to R⁴ may bond to each other to form a ring structure; R⁵ represents a substituted or unsubstituted alkyl group, or an alkyl group having a fluorine atom. The compound contains at least one fluorine atom in R^{1 to R}⁴; m indicates 0 or 1.

The substituted or unsubstituted alkyl group for R¹ to R⁴ preferably has from 1 to 30 carbon atoms, more preferably from 1 to 20 carbon atoms, and includes, for example, a methyl group, an ethyl group, an n-propyl group. The substituted alkyl group includes an aralkyl group. The aralkyl group preferably has from 7 to 30 carbon atoms, more preferably from 7 to 20 carbon atoms, and includes, for example, a benzyl group, a p-inethoxybenzyl group. In addition, a hydroxyalkyl group (e.g., hydroxyethyl group) and an alkoxyalkyl group (e.g., methoxyethyl group) are also within the scope of the substituted alkyl group. The substituent for the alkyl group includes those alkyl groups, and in addition, a halogen atom (e.g., fluorine atom, chlorine atom, bromine atom, iodine atom), an alkoxy group (e.g., methoxy group, ethoxy group), etc.

The alkyl group having a fluorine atom for R¹ to R⁴ includes a fluoroalkyl group having from 1 to 30 carbon atoms, preferably a perfluoroalkyl group having from 1 to 10 carbon atoms, more preferably a perfluoroalkyl group having from 1 to 4 carbon atoms.

The alkoxy group having a fluorine atom for R¹ to R⁴ includes a fluorine atom-containing alkoxy group having from 1 to 30 carbon atoms, preferably a perfluoroalkoxy group having from 1 to 10 carbon atoms.

The ether bond-containing alkyl group having a fluorine atom for R¹ to R⁴ includes a fluorine atom-containing alkoxy group having from 1 to 30 carbon atoms, preferably a perfluoroalkoxy group having from 1 to 10 carbon atoms.

For R¹ to R⁴, also preferred is —COOR⁵ or —OCOR⁵, in which R⁵ is preferably a substituted or unsubstituted alkyl group, more preferably a fluorine atom-having alkyl group. Of —COOR⁵ and —OCOR⁵, preferred is —COOR⁵.

Preferably, R¹ to R⁴ each are a fluorine atom, an alkyl group having a fluorine atom, or an alkoxy group having a fluorine atom, more preferably a fluorine atom or an alkyl group having a fluorine atom.

At least two of R¹ to R⁴ may bond to each other to form a ring structure. The cyclic structure may be a monocyclic structure or a polycyclic structure, but is preferably any other than the recurring unit structure indicated by m. For example, two of R¹ to R⁴ bond to each other to form an alkylene group. More concretely, any of R¹ and R² bonds to any of R² to R⁴ to form an alkylene group. Preferably, however, R¹ to R⁴ do not bond to each other to form a ring structure.

Preferably, a part of R¹ to R⁴ contains at least one fluorine atom, more preferably at least 3 fluorine atoms, even more preferably at least one trifluoromethyl group (—CF₃).

m indicates 0 or 1, preferably 0.

The fluorine-containing ring structure-having polymer may be a homopolymer comprising one type of a recurring unit alone or a copolymer comprising two or more different types of recurring units. The polymer may comprise only the recurring unit of formula (1) or may comprise a recurring unit of formula (1) and a recurring unit that differs from formula (1). The type of the recurring unit that differs from formula (1) to be employed in the latter case is not specifically defined so far as it does not too much detract from the advantage of the invention. In general, it is preferably a recurring unit derived from a copolymerizable vinyl compound; and preferred examples of the vinyl compound include α-olefins such as ethylene, propylene, 1-butene, 1-hexene, and styrene, cyclic olefins, etc. Of those, preferred are cyclic olefins; and more preferred are cyclic olefins capable of forming the same cyclic skeleton as that of formula (1) after polymerization. The proportion by weight of the structural unit of formula (1) to be in the fluorine-containing ring structure-having polymer is preferably from 30 to 100% by weight, more preferably from 50 to 100% by weight, even more preferably from 70 to 100% by weight.

In the resin composition for optical material of the invention, the weight-average molecular weight of the fluorine-containing ring structure-having polymer is preferably at least 20000 from the viewpoint of the mechanical properties of the shaped article of the composition, more preferably at least 40000, even more preferably at least 60000.

Preferably, the fluorine atom content in the fluorine-containing ring structure-having polymer is from 10% by mass to 75% by mass relative to the mass of the fluorine-containing ring structure-having polymer, more preferably from 20 to 65% by mass, even more preferably from 30 to 60% by mass.

Preferred examples of the fluorine-containing ring structure-having polymer usable in the invention are mentioned below, to which, however, the invention should not be limited. In the following examples, Mw means the weight-average molecular weight of the fluorine-containing ring structure-having polymer.

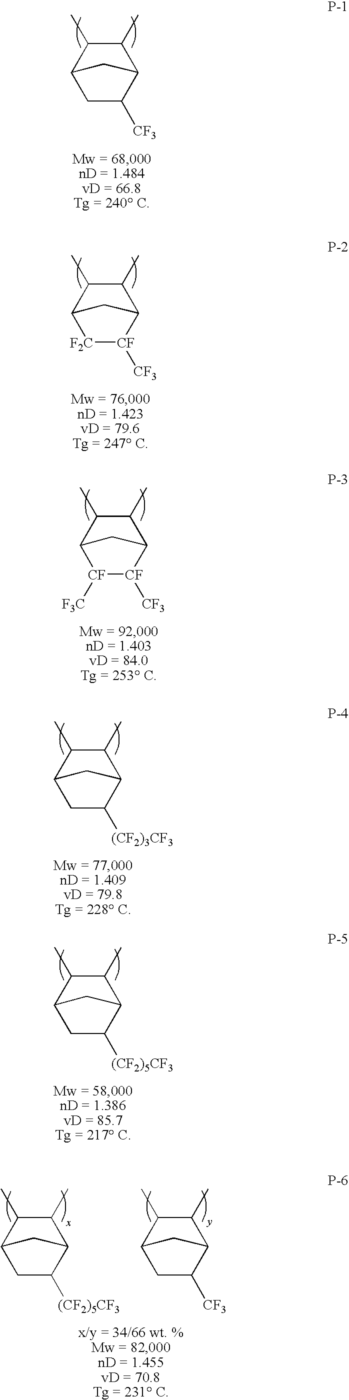

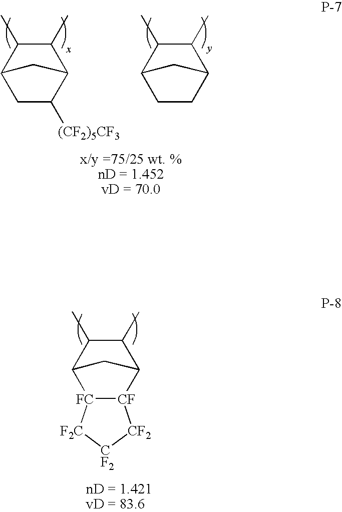

The resin composition for optical material of the invention may contain only one type of the fluorine-containing ring structure-having polymer alone or may contain two or more different types of those fluorine-containing ring structure-having polymers as combined.

The fluorine-containing ring structure-having polymer may be produced in any known method. Preferred is a method of addition polymerization of a fluorine-containing cyclic olefin.

For example, an especially preferred method comprises addition polymerization of a fluorine-containing cyclic olefin that has a double bond between the two carbon atoms constituting the main chain in the recurring unit structure of formula (1). For the condition of addition polymerization, conditions well known to those skilled in the art may be suitably optimized and employed.

### (Other Ingredients)

Not contradictory to the subject matter and the spirit of the invention, the resin composition for optical material of the invention may contain any other resin not falling within the scope of the specific resin for use in the invention and also additives such as dispersant, plasticizer, thermal stabilizer, release agent, etc.

The proportion of the fluorine-containing ring structure-having polymer to be in the resin composition for optical material of the invention is preferably from 40 to 100% by weight, more preferably from 60 to 100% by weight, even more preferably from 80 to 100% by weight.

### [Shaped Article]

Shaping the resin composition for optical material of the invention gives the shaped article of the invention.

The resin composition for optical material of the invention may be cast, using a solvent, to give a shaped article.

Preferably, however, the composition is shaped in solid, not using a solvent, according to an injection-molding method or a compression-molding method.

Preferably, the refractive index and the optical properties of the shaped article of the invention are those mentioned in the section of the description of the resin composition for optical material of the invention.

Preferably, the glass transition temperature of the shaped article of the invention is not lower than 100° C., more preferably from 120 to 300° C., even more preferably from 140 to 250° C.

The shaped articles of the invention preferably have a maximum thickness of 0.1 mm or more, more preferably 0.1 to 5 mm, still more preferably 1 to 3 mm. The shaped articles of such thickness are particularly useful as an optical component with a high refractive index. Shaped articles of such thickness are generally produced, with much difficulty, by solution cast methods, because the solvent therein can hardly be drawn out. When the resin composition for optical material of the invention is used, however, molding is readily done to readily prepare complicated shapes such as non-spherical shapes. As described above, in accordance with the invention, shaped articles with good transparency can be obtained, using the large refractive index properties of the fine particles.

[Optical Components]

The foregoing article is an article having high refraction properties, light transmission properties and lightweight properties and having excellent optical properties.

The optical component of the invention is configured of such an article. The type of the optical component of the invention is not particularly limited. In particular, the optical component of the invention can be favorably utilized as an optical component utilizing excellent optical properties of the resin composition for optical material, especially as an optical component capable of transmitting light therethrough (so-called passive optical component). Examples of optical functional devices provided with such an optical component include a variety of display devices (for example, liquid crystal displays, plasma displays), a variety of projector devices (for example, OHP, liquid crystal projectors), optical fiber communication devices (for example, optical waveguides, optical amplifiers) and imaging devices (for example, cameras, video cameras).

Also, examples of the passive optical component to be used in an optical functional device include lenses, prisms, panels (plate-like moldings), films, optical waveguides (for example, film forms, fiber forms) and optical discs. If desired, such a passive optical component may be of a multilayered structure provided with an arbitrary coating layer such as arbitrary additional functional layers, for example, a protective layer for preventing mechanical damages on the coated surface due to friction or abrasion, a light absorbing layer for absorbing light beams of an undesired wavelength which become a cause for deteriorating the inorganic particle or base material or the like, a transmission-blocking layer for suppressing or preventing the transmission of a reactive low-molecular weight molecule such as water and an oxygen gas, an antiglare layer, an antireflection layer and a low-refractive index layer. Specific examples of such an arbitrary coating layer include a transparent conductive membrane or a gas barrier membrane composed of an inorganic oxide coating layer; and a gas barrier membrane or a hard coat composed of an organic material coating layer. As the coating method, there can be employed known coating methods such as a vacuum vapor deposition method, a CVD method, a sputtering method, a dip coating method and a spin coating method.

[Lens]

The optical component using the resin composition for optical material of the invention is especially favorable for a lens base material. The lens base material manufactured using the resin composition for optical material of the invention has high refraction properties, light transmission properties and lightweight properties and is excellent in optical properties. Also, by properly adjusting the type of the monomer constituting the resin composition for optical material, it is possible to arbitrarily adjust the refractive index of the lens base material.

The “lens base material” as referred to in the invention refers to a single member capable of exhibiting a lens function. A membrane or a member can be provided on the surface or surroundings of the lens base material depending upon the use circumference or utilization of the lens. For example, a protective membrane, an antireflection membrane, a hard coat membrane and the like can be formed on the surface of the lens base material. Also, the surroundings of the lens base material can be put in and fixed to a base material holding frame or the like. However, such a membrane or frame is a member to be added to the lens base material as referred to in the invention and should be distinguished from the lens base material per se as referred to in the invention.

In utilizing the lens base material in the invention as a lens, the lens base material per se of the invention may be solely used as a lens, or as described previously, it may be added to a membrane or frame and then used as a lens. The type and shape of the lens using the lens base material of the invention is not particularly limited. The lens base material of the invention is used for, for example, spectacle lenses, optical instrument lenses, optoelectronic lenses, laser lenses, pickup lenses, vehicle-mounted camera lenses, mobile phone camera lenses, digital camera lenses, OHP lens, lenses for configuring a micro lens array.

### EXAMPLES

The characteristics of the invention are hereunder described in more detail with reference to the following Examples. Materials, use amounts, proportions, treatment contents, treatment procedures and the like as shown in the following Examples can be properly changed. In consequence, it should not be construed that the scope of the invention is limitedly interpreted.

[Production of fluorine-containing ring structure-having polymer]
(1) Production of fluorine-containing ring structure-having polymer (P-1, P-2, P-3, P-4, P-5, P-6):

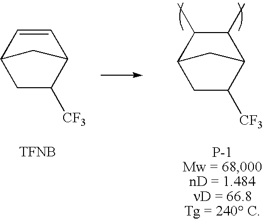

Toluene (BOO mL) and trifluoromethylnorbornene (TFNB) (164.2 g, 1.0 mol) were put into a reactor. Next, a solution prepared by reacting palladium bisacetylacetonate (by Tokyo Chemical) (54.9 mg) and tricyclohexyl phosphine (by Strem) (50.5 mg) in toluene (5 mL) was added, and this was washed with toluene (2.9 mL). Next, dimethylanilinium tetrakispentafluorophenylborate (by Strem) (288 mg) was added, and this was washed with toluene (7 mL). The solution was stirred in a nitrogen current at 80° C. for 3 hours. The resulting solution was diluted with toluene (4 L), and acetone (12 L) was added thereto for reprecipitation. The precipitate was collected by filtration, and dried in vacuum at 80° C. for 3 hours to give a white solid, P-1. The obtained thermoplastic resin

P-1 was dissolved in heavy chloroform, and analyzed through ¹H-NMR, which confirmed that the product was a 100% polymer with no remaining monomer.

P-2, P-3, P-4, P-5 and P-6 were produced in the same manner as that for P-1, for which, however, the type of the monomer, the monomer concentration and the catalyst concentration were changed.

(2) Production of comparative polymer A, comparative polymer B:

The polymer A and the polymer B described in JP-A 2007-177046 were produced according to the method described in the patent publication.

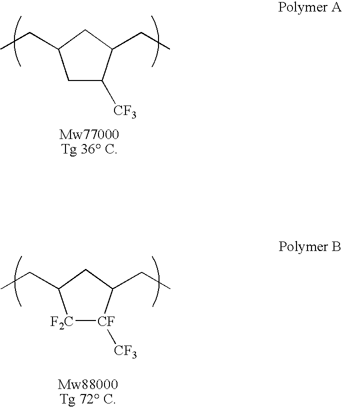

(3) Production of comparative polymer C:

To a mixture of hexylnorbornene (1 g), 5-(perfluorobutyl) norbornene (1.17 g) and lithium tetrakis(pentafluorophenyl)borate/2.5 ether (1.6 mg), added was allylpalladium (tricyclohexylphosphine)trifluoroacetate (0.0128 M methylene chloride solution) (0.03 mL). After the reaction system thickened, a large excessive amount of acetone was added thereto for reprecipitation. The precipitate was collected by filtration, and dried in vacuum at 80° C. for 3 hours to give a white solid. The obtained white solid was dissolved in heavy chloroform, and analyzed through ¹H-NMR, which confirmed that the product was a 100% polymer of hexylnorbornene (polymer C)

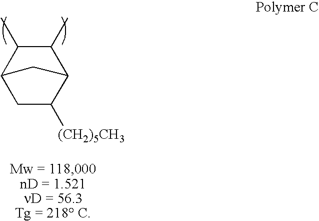

### [Analysis of Polymer]

The obtained polymers were analyzed as follows. (1) Measurement of refractive index and computation for Abbe's number:

The polymer was compression-molded under heat to give a 200-μm film. Its refractive index was measured at a wavelength of 589 nm, using an Abbe refractiometer (Atago's DR-M2) . The Abbe's number of the polymer was determined through computation based on the data at a wavelength of 489 nm, 589 nm and 656 nm found with an Abbe refractiometer (Atago's DR-M2).

### (2) Measurement of Molecular Weight:

The molecular weight of each polymer is a weight-average molecular weight measured in terms of polystyrene through GPC under the condition mentioned below.

Apparatus: HLC-8121GPC/HT (by Tosoh),

Column: TSK_{gel} GMH_{HR}-H(20)HT (7.8 mm×300 mm), 2 columns,

Detector: RI detector with built-in HLC-8221GPC/HT,

Solvent: o-dichlorobenzene,

Flow rate: 1 mL/min,

Temperature: 145° C.,

Sample amount: 500 μl. (0.2% solution),

Standard sample: monodispersed polystyrene ×16 (by Tosoh).

(3) Measurement of glass transition temperature:

The glass transition temperature (hereinafter referred to as Tg) of the polymer was measured as follows: Using a differential scanning calorimeter (DSC6200, by Seiko Instruments), the sample was analyzed in nitrogen at a heating speed of 10° C./min.

[Production of Transparent Shaped Article]

The polymer produced in the above was melted, put into a stainless mold, and compression-molded under heat to give a transparent shaped article having a thickness of 1 mm. In compression-molding under heat, the polymer was controlled at a temperature higher by 100° C. than the glass transition temperature thereof (Tg+100° C.), and molded under a pressure of 13.7 MPa for 2 minutes. The light transmittance of the shaped article was measured. The mold releasability of the article was evaluated according to the standards mentioned below. The results are shown in Table 1 below.

### [Analysis and Evaluation of Transparent Shaped Article]

(1) Measurement of light transmittance:

Using a UV-visible light absorption spectrometer (UV-3100 by Shimadzu), the light transmittance of the shaped article was measured.

### (2) Mold Releasability:

After thermally molded, the shaped article was released form the stainless mold, whereupon it was evaluated through sensory evaluation in point of the easiness in releasing the button from the mold, according to the criteria mentioned below.

◯: The button was released spontaneously from the mold.

Δ: The button was released from the mold when a little force was applied thereto.

X: The button could be released only when much force was applied thereto.

### (3) In-Mold Residue:

After thermally molded, the shaped article was released from the stainless mold, whereupon the mold was checked for the in-mold residue, if any, according to the criteria mentioned below.

◯: No in-mold residue remained.

Δ: A little in-mold residue remained.

X: Much in-mold residue remained.

TABLE 1

| | Polymer | | | | | | | | | |
|---|---|---|---|---|---|---|---|---|---|---|
| | | Fluorine | | | | Weight- | | | | |
| | | Atom | Refractive | | Abbe's | Average | | Shaped Article | | |
| | | Content | Index | Abbe's | Number − | Molecular | Tg | Transmittance | Mold | In-Mold |
| | Resin | (% by mass) | nD | Number | (430 − 250 × nD) | Weight | (° C.) | (%) | Releasability | Residue |
| Example 1 | P-1 | 35.2 | 1.484 | 66.8 | 7.95 | 68000 | 240 | 79 | ◯ | ◯ |
| Example 2 | P-2 | 52.7 | 1.423 | 79.6 | 5.45 | 76000 | 247 | 80 | ◯ | ◯ |
| Example 3 | P-3 | 57.1 | 1.403 | 84.0 | 4.75 | 92000 | 253 | 81 | ◯ | ◯ |
| Example 4 | P-4 | 54.8 | 1.409 | 79.8 | 1.97 | 77000 | 228 | 78 | ◯ | ◯ |
| Example 5 | P-5 | 59.9 | 1.386 | 85.7 | 2.11 | 58000 | 217 | 78 | ◯ | ◯ |
| Example 6 | P-6 | 41.9 | 1.455 | 70.8 | 4.51 | 82000 | 231 | 80 | ◯ | ◯ |
| Comparative | Polymer | 34.7 | 1.468 | 64.7 | 1.68 | 77000 | 36 | 71 | Δ | Δ |
| Example 1 | A | | | | | | | | | |
| Comparative | Polymer | 52.3 | 1.414 | 75.7 | −0.82 | 88000 | 72 | 68 | Δ | Δ |
| Example 2 | B | | | | | | | | | |
| Comparative | Polymer | 0 | 1.521 | 56.3 | 6.55 | 118000 | 218 | 78 | ◯ | ◯ |
| Example 3 | C | | | | | | | | | |

From Table 1, it is known that, according to Examples of the invention, optical materials satisfying both high refractivity and high Abbe's number and having good heat resistance and excellent transparency can be obtained. It is confirmed that the resin composition for optical material of the invention has excellent mold releasability and can produce lens profiles with accuracy and with good producibility in accordance with the mold profile for concave lenses, convex lenses, etc.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 326110/2008 filed on Dec. 22, 2008, which is expressly incorporated herein by reference in its entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. A resin composition for optical material, having a refractive index nD at a wavelength of 589 nm of at least 1.37, an Abbe's number vD satisfying vD≦63 and vD≦430−250×nD, and a glass transition temperature of not lower than 100° C.

2. The resin composition for optical material according to claim 1, having a refractive index nD at a wavelength of 589 nm of at least 1.42.

3. The resin composition for optical material according to claim 1, having an Abbe's number vD of at least 70.

4. The resin composition for optical material according to claim 1, having a glass transition temperature of from 140° C. to 250° C.

5. A resin composition for optical material, containing a polymer having a fluorine-containing ring structure and having a recurring unit represented by the following formula (1): 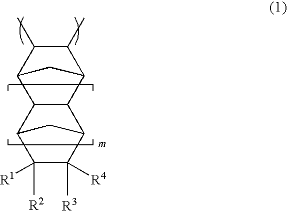
wherein R¹ to R⁴ each independently represent a hydrogen atom, a fluorine atom, a substituted or unsubstituted alkyl group, an alkyl group having a fluorine atom, an alkoxy group having a fluorine atom, an ether bond-containing alkyl group having a fluorine atom, or a substituent of —COOR^{S} or —OCOR⁵;
at least two of R¹ to R⁴ may bond to each other to form a ring structure;
R⁵ represents a substituted or unsubstituted alkyl group, or an alkyl group having a fluorine atom;
the compound contains at least one fluorine atom in R¹ to R⁴; and
m indicates 0 or 1.

6. The resin composition for optical material according to claim 5, wherein the polymer having a fluorine-containing ring structure has a weight-average molecular weight of at least 20000.

7. The resin composition for optical material according to claim 5, wherein the polymer having a fluorine-containing ring structure contains a fluorine atom in an amount of from 10% by mass to 75% by mass relative to the mass of the polymer.

8. The resin composition for optical material according to claim 5, having a glass transition temperature of not lower than 100° C.

9. The resin composition for optical material according to claim 5, having a refractive index nD at a wavelength of 589 nm of at least 1.42.

10. The resin composition for optical material according to claim 5, having an Abbe's number vD at a wavelength of 589 nm of at least 63.

11. The resin composition for optical material according to claim 5, having an Abbe's number vD at a wavelength of 589 nm satisfying vD≦430−250×nD wherein nD indicates the refractive index of the resin composition at a wavelength of 589 nm.

12. The resin composition for optical material according to claim 5, wherein R¹ to R⁴ in the formula (1) each are selected from the group consisting of a fluorine atom, an alkyl group having a fluorine atom, and an alkoxy group having a fluorine atom.

13. A shaped article formed by shaping the resin composition for optical material of claim 1.

14. The shaped article according to claim 13, having a light transmittance at a wavelength of 589 nm through a thickness thereof of 1 mm of at least 50%.

15. The shaped article according to claim 13, which is an optical component.

16. The shaped article according to claim 13, which is a lens.

17. A shaped article formed by shaping the resin composition for optical material of claim 5.

18. The shaped article according to claim 17, having a light transmittance at a wavelength of 589 nm through a thickness thereof of 1 mm of at least 50%.

19. The shaped article according to claim 17, which is an optical component.

20. The shaped article according to claim 17, which is a lens.
